(19) United States
(12) Patent Application Publication
(10) Pub. No.: US 2026/0046235 A1
(43) Pub. Date: Feb. 12, 2026

(54) METHODS, SYSTEMS, AND COMPUTER READABLE MEDIA FOR PROVIDING A NETWORK TEST ENVIRONMENT WITH VARIABLE EMULATION FIDELITY

(71) Applicant: Keysight Technologies, Inc., Santa Rosa, CA (US)

(72) Inventors: Venkateshwar Rao Pullela, San Jose, CA (US); Ram Periakaruppan, Agoura Hills, CA (US); Alexander Bortok, Mountain View, CA (US); Peter J. Marsico, Chapel Hill, NC (US)

(21) Appl. No.: 19/365,139

(22) Filed: Oct. 21, 2025

Related U.S. Application Data
(63) Continuation of application No. 18/385,183, filed on Oct. 30, 2023.
(60) Provisional application No. 63/529,885, filed on Jul. 31, 2023.

(51) Int. Cl. H04L 43/55; H04L 41/16

(52) U.S. Cl. CPC H04L 43/55; H04L 41/16

(57) ABSTRACT

Methods, systems, and computer readable media for providing a network test environment with variable emulation fidelity are disclosed. According to one method, the method occurs at a test system implemented using at least one processor. The method includes receiving test configuration information associated with a test session for configuring a test environment comprising a plurality of test bed elements (TBEs); configuring, using the test configuration information and available test system resources, the plurality of TBEs, wherein configuring the plurality of TBEs includes selecting a first TBE of the plurality of TBEs providing a higher fidelity than a second TBE of the plurality of TBEs; initiating the test session involving the test environment; and obtaining test results associated with the test session.

### PRIORITY CLAIM

This application is a continuation of U.S. patent application Ser. No. 18/385,183, filed Oct. 30, 2023, which claims the priority benefit of U.S. Provisional Patent Application Ser. No. 63/529,885, filed Jul. 31, 2023, the disclosure of which is incorporated herein by reference in its entirety.

### TECHNICAL FIELD

The subject matter described herein relates to network testing. More particularly, the subject matter described herein relates to providing a network test environment with variable emulation fidelity.

### BACKGROUND

Network operators may perform testing of a network or nodes therein before or after deployment. When testing network environments, it may be desirable to design a test session or a set of test sessions such that a system under test (SUT) is tested using real-world scenarios and conditions in a realistic environment or infrastructure. With some network test systems, a device or system under test is connected to one or more types of test bed elements. However, sometimes a test operator may not know which types of test bed elements are needed for achieving a test objective efficiently. As such, testing using different environments or infrastructures can be difficult and/or inefficient with such network test systems due to the time and human resource intensive nature involved in manually configuring test infrastructures.

### SUMMARY

Methods, systems, and computer readable media for providing a network test environment with variable emulation fidelity are disclosed. According to one method, the method occurs at a test system implemented using at least one processor. The method includes receiving test configuration information associated with a test session for configuring a test environment comprising a plurality of test bed elements (TBEs); configuring, using the test configuration information and available test system resources, the plurality of TBEs, wherein configuring the plurality of TBEs includes selecting a first TBE of the plurality of TBEs providing a higher fidelity than a second TBE of the plurality of TBEs; initiating the test session involving the test environment; and obtaining test results associated with the test session.

According to one system, the system includes a test system implemented using at least one processor. The test system is configured for: receiving test configuration information associated with a test session for configuring a test environment comprising a plurality of TBEs; configuring, using the test configuration information and available test system resources, the plurality of TBEs, wherein configuring the plurality of TBEs includes selecting a first TBE of the plurality of TBEs providing a higher fidelity than a second TBE of the plurality of TBEs; initiating the test session involving the test environment; and obtaining test results associated with the test session.

The subject matter described herein may be implemented in software in combination with hardware and/or firmware. For example, the subject matter described herein may be implemented in software executed by a processor (e.g., a hardware-based or physical processor). In one example implementation, the subject matter described herein may be implemented using a non-transitory computer readable medium having stored thereon computer executable instructions that when executed by the processor of a computer control the computer to perform steps. Example computer readable media suitable for implementing the subject matter described herein include non-transitory devices, such as disk memory devices, chip memory devices, programmable logic devices, such as field programmable gate arrays, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The subject matter described herein will now be explained with reference to the accompanying drawings of which:

FIG. 1 is a diagram illustrating an example network test environment with variable emulation fidelity;

FIG. 2 is a diagram illustrating an example process utilizing a network test environment with variable emulation fidelity;

FIG. 3 is a diagram illustrating an example artificial intelligence or machine learning (AI/ML) model builder utilizing training data derived from testing;

FIG. 4 is a diagram illustrating example emulation fidelity selection information; and

FIG. 5 is a diagram illustrating an example process for providing a network test environment with variable emulation fidelity.

### DETAILED DESCRIPTION

The subject matter described herein relates to methods, systems, and computer readable media network for providing a network test environment with variable emulation fidelity. When testing networks or other system(s) under test (SUT), it may be desirable to test equipment using different test environments or infrastructures, e.g., test bed elements (TBEs) with different emulation fidelity levels (e.g., higher fidelity elements have the ability to accurate represent or emulate a real or non-emulated device). However, testing using different test environments or TBEs with different emulation fidelities can be difficult, time consuming, expensive, and/or inefficient especially when test operators must manually configure test beds or TBEs thereof.

In accordance with some aspects of the subject matter described herein, a test system or a related entity may provide a network test environment with variable emulation fidelity. For example, a test system in accordance with some aspects of the subject matter described herein may be configured for receiving test configuration information associated with a test session for configuring a test environment comprising a plurality of TBEs; configuring, using the test configuration information and available test system resources, the plurality of TBEs, wherein configuring the plurality of TBEs includes selecting a first TBE of the plurality of TBEs providing a higher fidelity than a second TBE of the plurality of TBEs; initiating the test session involving the test environment; and obtaining test results associated with the test session.

In accordance with some aspects of the subject matter described herein, a test system controller or a related entity may automatically determine, e.g., based on user intent or a user's declaration, how to configure a network test system so as to allocate high fidelity TBEs (e.g., using test system resources or emulation resources) to areas of interest (e.g., in the test bed or test environment), while deploying lower fidelity TBEs to other areas (e.g., areas that are not of interest or that are less critical for achieving a test objective). In some embodiments, selecting test system resources or TBEs may be test objective dependent, and may change the TBEs or types of TBEs for a given test bed topology as test objectives change. For example, for a series of related test sessions, a test system controller may keep the number of TBEs in a test bed the same but may change the distribution of high fidelity TBEs and low fidelity TBEs within the test bed. In some embodiments, a test system controller or a related entity may provide a network test environment with per-iteration variations in emulation fidelity. For example, a test system or a related entity may run a test session with a particular test bed configuration, analyze test results associated with that test bed configuration, and generate feedback information that causes emulation fidelity adjustment for certain TBEs in the test bed. In this example, each subsequent test session may involve an adjusted test bed based in part on prior test results.

In accordance with some aspects of the subject matter described herein, a test system or a related entity may generate or collect data (e.g., network performance data, captured traffic, metadata, etc.) usable for training artificial intelligence and/or machine learning (AI/ML) models. For example, a test system may configure a test bed with various TBEs, execute a test session involving the test bed, and collect data during this test execution. In this example, the test system or another entity may use the collected data to train an AI/ML model, test the AI/ML model, and if the model performs poorly, may cause the test system to reconfigure the test bed with higher fidelity TBEs emulations in key areas and re-run the test to generate new higher fidelity data (e.g., more detailed, more precise and/or accurate data), include the higher fidelity data in an AI/ML training dataset, re-train the AI/ML model using the updated AI/ML training dataset.

By providing a network test environment with variable emulation fidelity, an example network test system can perform network testing involving a SUT or a device under test (DUT) that may not have been possible using previous test systems or that may have been very time consuming, expensive, and potentially prone to human-error (e.g., because of manual configuration of TBEs). Further, by providing a network test environment with variable emulation fidelity, an example network test system or a related entity can execute test session to obtain useful training data efficiently, which can be used in generating and training effective AI/ML models.

Reference will now be made in detail to example embodiments of the subject matter described herein, examples of which are illustrated in the accompanying drawings. Wherever possible, the same reference numbers will be used throughout the drawings to refer to the same or like parts.

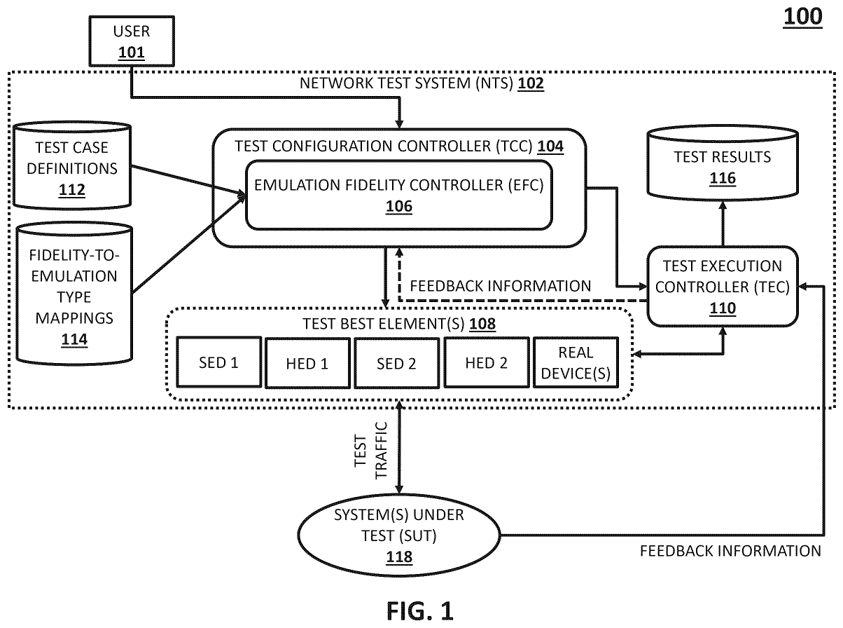

FIG. 1 is a diagram illustrating a network test environment 100 with variable emulation fidelity. Test environment 100 may include one or more networks, nodes, and/or devices (e.g., a network test system (NTS) 102) for testing one or more system(s) under testing (SUT) 118. NTS 102 may represent any suitable entity or entities (e.g., one or more testing platforms, nodes, or devices) associated with monitoring and/or testing SUT 118 and may include functionality for selecting and configuring TBEs 108, e.g., software-based emulated devices (SEDs), hardware-based emulated devices (HEDs), or real or non-emulated devices. For example, NTS 102 or a related entity may select a particular TBE 108 based on an emulation fidelity provided by the TBE and needed for testing. In this example, NTS 102 or a related entity may select an SED for testing when a low emulation fidelity is needed, select an SED for testing when a moderate emulation fidelity is needed, and select a real device for testing when a high emulation fidelity is needed.

In some embodiments, NTS 102 may include a stand-alone tool, a testing device, a network equipment test device or platform, or software executing on one or more processor(s). In some embodiments, NTS 102 may be a single device or node or may be distributed across multiple devices or nodes, e.g., a cloud based test system. In some embodiments, NTS 102 may include one or more modules for performing various test related functions. For example, NTS 102 may include functionality for emulating TBEs 108 or other nodes or entities and may communicate with SUT 118 or other entities using various internal and/or external communications interfaces.

NTS 102 may include or interact with a user 101, a test configuration controller (TCC) 104, an emulation fidelity controller (EFC) 106, a test execution controller (TEC) 110, TBE(s) 108, and various data stores comprising test related information, such as test case definitions 112, fidelity-to-emulation type mappings 114, and test results 116.

User 101 may represent a human or another entity (e.g., a management system) that interacts with NTS 102 or related entities. For example, user 101 may interact with one or more of user interfaces (UIs) or graphical user interfaces (GUIs) for selecting test content (e.g., test sessions, test templates, test case definitions, etc.), configuring test sessions or TBE(s) 108, reviewing or analyzing test results or performance metrics, and/or interacting with other test related entities.

TCC 104 may be any suitable entity or entities (e.g., (e.g., software executing on a processor, a field-programmable gateway array (FPGA), an application-specific integrated circuits (ASIC), or a combination of software, an ASIC, or an FPGA) for performing configuration functions or related aspects. For example, TCC 104 may provide one or more UIs for allowing user 101 to provide configuration information for a test scenario and/or interact with NTS 102 or related entities. In some embodiments, TCC 104 may allow user 101 to browse, add, modify, remove, or select data from one or more data stores, e.g., test case definitions 112, fidelity-to-emulation type mappings 114, or other test content (e.g., stored in data storage 112) via a GUI or other UI. In such embodiments, test content may be selected for configuring test environment 100, TBE(s) 108, and/or other test related entities. For example, via TCC 104, user 101 can select a test case definition indicating a test scenario or objective, a test bed, or a set of TBEs 108 for a test session (e.g., based on a user-provided test objective and mappings 114), can provide additional configuration information needed for setting up each TBE 108 associated with the test session; can provide various other settings or configurations associated with executing the test session, and/or can provide or display test related information about the test session to user 101.

In some embodiments, TCC 104 may support automation e.g., via one or more programming languages (e.g., python), a representation state transfer (REST) application programming interface (API), a remote procedure call API (e.g., gRPC API), a command line interface (CLI), a machine-to-machine (M2M) automation interface, and/or a web based GUI.

EFC 106 may be any suitable entity or entities (e.g., software executing on one or more compute resources) for performing one or more aspects associated with selecting or determining appropriate TBE(s) 108 for a test session using test objectives, areas of interest, emulation fidelity attributes (e.g., data or metrics that are indictive of a fidelity level), or other information. For example, assuming a test objective is related to monitoring particular data paths or certain traffic traversing a test bed, EFC 106 may select and configure high (er) fidelity TBEs 108 (e.g., HEDs or real network switch devices) in the test bed for obtaining metrics or data related to these paths or traffic, while utilizing low (er) fidelity TBEs 108 (e.g., HEDs or real network switch devices) elsewhere in the test bed. In another example, assuming a test objective is related to monitoring QoS attributes of traffic shaping user plane traffic, EFC 106 may select and configure high (er) fidelity TBEs 108 (e.g., HEDs or real network switch devices) in the test bed for obtaining detailed QoS metrics or data related to the traffic shaping of the user plane traffic, while utilizing low (er) fidelity TBEs 108 (e.g., HEDs or real network switch devices) elsewhere in the test bed.

Table 1 shown below depicts some example emulation fidelity attributes, e.g., details, metrics, or other information associated with testing and can determine or affect which TBE 108 to deploy or utilize in a test environment or a related test session. In some embodiments, an emulation fidelity attribute can be an operational status metric, a performance metric, or a test execution artifact associated with a TBE or a non-emulated version thereof. It will be appreciated that the information provided in Table 1 is not intended to be a complete listing of all possible emulation fidelity attributes.

TABLE 1

Memory Attributes-high bandwidth
memory (HBM) data, static random-
access memory (SRAM) data, ternary
content-addressable memory
(TCAM) data, dual port/multi-port data,
dynamic random-access memory
(DRAM) data, etc.
Storage Attributes-solid-state drive
(SSD) data, hard disk drive (HDD)
data, etc.
Port Attributes-queue data, shared
buffer data, network/fabric (NW/Fabric)
interface data, transceiver data,
serializer/deserializer (SERDES) data,
speed data, etc.
System Attributes-central processing
unit (CPU) data, graphics processing
unit (GPU) data, management port data,
timing port data, power supplies
data, etc.
Processing Attributes-redundant
power/signal processor (RP/SP) data,
network interface card (NIC) data,
accelerators data, etc.
Bus Attributes-peripheral component
interconnect express (PCIe) data,
compute express link (CXL) data,
custom data, direct memory access
(DMA) data, etc.
Algorithm Attributes-metrics from
implementations involving equal cost
multi-path (ECMP), network cells,
link aggregation, P4 code, hashing
algorithms, schedulers, sawtooth nodes, etc.
Networking Attributes-packet processor
metrics, pipeline metrics, line card
fabric metrics, port metrics, etc.
Quality of Service (QoS) Attributes-
virtual output queueing (VoQ) metrics,
traffic shaper metrics, rate limiter metrics, etc.
Key Performance Indicator (KPI)
Attributes-performance metrics, latency
metrics, drop metrics, mis-ordering metrics, etc.
Protocol Attributes-congestion control
protocols metrics, security or
authentication protocols metrics, etc.

In some embodiments, emulation fidelity attributes may be specified in a test case definition, which is a test system construct used to describe a test bed environment, its TBEs 108, and associated test execution parameters. For example, a test case definition may specify that a network switch should be emulated during execution of a test session and may indicate that an emulation fidelity attribute includes port queue depth metrics from that network switch. In response to this test case definition or requirement, NTS 102 or a related entity (e.g., TCC 104 or EFC 106) may choose to deploy the network switch in the test environment as a hardware emulation (as opposed to a software emulation) prior to initiation of the test, where the hardware emulation is configured to generate and report port queue depth metrics associated with the emulated switch during or after execution of a test.

In some embodiments, emulation fidelity attributes or other selection criteria may indicate that some TBEs or types of TBEs are appropriate or inappropriate for a particular test environment or test session. For example, at one extreme, a low fidelity software emulation of a TBE may only be capable of accurately mimicking a small number of emulation fidelity attributes or related metrics but software emulations may be advantageous (e.g., cost effective) in test scenarios that require a large and/or complex test bed topology. At the other extreme, a highest fidelity “emulation” of a TBE may involve using a non-emulated or real device may provide or represent a “perfect” emulation. In between the software emulations and the real devices, a medium fidelity emulation of a TBE may involve deploying an emulation on a hardware-based emulator, where the hardware emulation is capable of accurately mimicking a range of emulation fidelity attributes that cannot be easily reproduced via a software emulation. In general, hardware emulations may not be scaled as cost-effectively as software emulations but may be more cost effective than using real devices.

In one example or use case scenario, a test may be initially configured (e.g., by NTS 102 and/or with user input) such that it includes low fidelity software emulations (e.g., SEDs or software emulated TBEs) that mimic the behavior of a network function and an associated network attached storage resource. The low fidelity software emulations may mimic the outward or externally visible behavior of the network function and network attached storage resource, but does not mimic the internal signaling or messaging traffic (e.g., Remote Direct Memory Access over Converged Ethernet (RoCE) traffic, etc.) that would be generated across communication links connecting the two elements if they were real or non-emulated (e.g., a non-emulated network function and a non-emulated network attached storage resource). In this example, after the test is executed, it may be subsequently determined (e.g., by user 101 or automatically by NTS 102 or a related entity) that more details about the communications between the emulated network function and the emulated network attached storage resource are needed. As such, the test environment (e.g., test bed) may be re-configured (e.g., by NTS 102 and/or with user input) such that a higher fidelity version of the network function and the network attached storage resource are implemented. For instance, higher fidelity hardware emulations of the network function and the network attached storage resource may be selected (e.g., by NTS 102 or EFC 106) from a pool of TBEs 108 (e.g., test system resources) and implemented in the test environment. The selected higher fidelity TBEs 108 may be capable of generating or emulating signaling or messaging traffic that is or would be communicated across communication links connecting the two TBEs 108. Continuing with this example, the test may be re-executed (e.g., by NTS 102) using the higher fidelity TBEs 108 and results may be generated and reported, including details about the signaling and/or messaging between the higher fidelity TBEs 108, e.g., the hardware emulations of network function and the network attached storage resource. It will be appreciated that in this example and similar scenarios, user 101 can selectively and dynamically “zoom in” on the operational details about various elements (e.g., TBEs 108) and/or aspects of a test environment (e.g., a test bed) during testing. This same approach or a similar one can be used to “zoom in” on an area of a test environment, e.g., by causing NTS 102 to implement higher fidelity TBEs 108 where needed and to selectively obtain or observe more detailed operational behaviors within a test environment, e.g., inter-element communication link congestion behavior, device-level congestion behavior, device-level CPU or GPU utilization levels, etc. Also, if fine-grained or detailed behavior for an area or aspect of a test environment is not required, user 101 can effectively “zoom out” by causing NTS 102 to implement or deploy lower fidelity TBEs 108 (e.g., test system resources) in selected areas of the test environment.

In some embodiments, EFC selection logic (e.g., executed by NTS 102 or EFC 106) may be affected by prior selected TBEs 108 or their related behaviors or capabilities. For example, when setting up a test environment comprising TBEs 108 with different levels of fidelity, issues can arise when connecting different types or emulation tiers, e.g., a software emulation of a network switch may be incapable of receiving or processing traffic at the same speed as a real network switch or a hardware emulated version. In this example, EFC selection logic (e.g., executed by NTS 102 or EFC 106) may automatically select and implement TBEs 108 with differing levels of fidelity that do not cause issues that would prevent a test objective from being achieved, e.g., TBEs 108 may be selected to match speeds and handling capacity of another side or end of a link or connection.

In some embodiments, e.g., after selecting appropriate TBE(s) 108, TCC 104 and/or EFC 106 may perform various actions associated with orchestrating a test session. For example, orchestrating a test session may involve interpreting, generating, performing configuration actions associated with a test session or a related test case definition. In this example, EFC 106 may generate commands or instructions responsible for configuring or standing up TBEs 108 needed for a particular test session.

TBEs 108 represents test environment elements or underlying resources that can be utilized and deployed for testing. For example, TBEs 108 may be set up and configured using available test system resources including compute resources (e.g., servers, processors, FPGAs, ASICs, etc.) that can execute virtual or emulated devices, such as HEDs and SEDs. In another example, TBEs 108 may be non-emulated devices that can be configured or deployed for various purposes.

In some embodiments, TBEs 108 may be software emulations (e.g., SEDs), hardware emulations (e.g., HEDs), or real devices (e.g., non-emulated, physical device). For example, a SED or software emulation of a TBE may be an emulation intended to mimic the behavior of physical or non-emulated device and may be implemented primarily using software running on a general-purpose processor, such as a CPU/CPU-like processor; a HED or a hardware emulation of a TBE may be an emulation intended to the behavior of physical or non-emulated device and may be implemented primarily using firmware or software running on an ASIC, a programmable ASIC, or an FPGA processor; and a real device may be a production or development version of a physical or non-emulated device.

In some embodiments, SEDs or software emulations may be implemented using general purpose computing platforms, such as CPU-based servers, virtual machines or containers, or cloud-based platforms. SEDs or software emulations may be the most cost effective relative to HEDs or real devices, may also provide lower fidelity than HEDs and real devices. In some embodiments, SEDs or software emulations may be easily scaled to enable software-based simulations of test environments comprising large numbers of TBEs 108 in a highly cost-effective manner. In some embodiments, SEDs or software emulations may typically be utilized in scenarios where mimicry of an application or software aspect of a real device is a test objective or impacts a test objective.

In some embodiments, HEDs or hardware emulations may be implemented using purpose-built and/or customizable processing platforms, such as ASIC or programmable ASIC processing platforms and/or FPGA processing platforms. HEDs or hardware emulations may be more cost effective than real devices but less cost effective than SEDs or software emulations. HEDs or hardware emulations may also provide lower fidelity than real devices but higher fidelity than SEDs or software emulations. In some embodiments, HEDs or hardware emulations may be more difficult to scale than SEDs or software emulations. In some embodiments, HEDs or hardware emulations may typically be utilized in scenarios where mimicry of the software the underlying hardware behavior of a real device is a test objective or impacts a test objective.

Real devices may include production or development versions of physical or non-emulated devices or elements. Real devices may generally provide higher fidelity than emulations including HEDs and SEDs. While this type of TBEs 108 generally provide the highest of fidelity, they are typically the least cost effective and, as such, it can be cost prohibitive to deploy such devices at scale, especially in a large or complex test environment.

In some embodiments, TBEs 108 may be classified or grouped (e.g., by EFC 106) using various criteria, e.g., deployment locations (e.g., SUT elements and non-SUT elements), device type/usage, fidelity level, technology, communications standards or protocols, speeds, capabilities, etc. Example TBEs 108 may include, but are not limited to, emulated or non-emulated devices (e.g., virtual or physical devices). In some embodiments, TBEs 108 may include switches, smartswitches, routers, servers, processing offload or accelerator devices, machine learning processors, data center elements, open radio access network (O-RAN) elements, fifth generation (5G) or sixth generation (6G) core network elements, etc.

TEC 110 may be any suitable entity or entities (e.g., software executing on one or more compute resources) for performing one or more aspects associated with executing or managing a test session and/or collecting test results. For example, executing a test session may involve starting, stopping, or pausing test traffic generation and/or performance monitoring using one or more commands sent to TBE(s) 108 or other test related entities, e.g., via a management network.

In some embodiments, TEC 110 may be configured to initiate and manage execution of a test session involving TBE(s) 108. For example, TEC 110 may communicate with and control TBEs 108 (e.g., emulated switching fabric, traffic generators, network taps, visibility components, switches, etc.) during a test session and may use these TBE(s) 108 to cause them to transmit or forward test traffic or related responses. In another example, TEC 110 may communicate with and control TBEs 108 to gather and store test results 116, e.g., captured or copied traffic, telemetry data, or performance metrics. In another example, TEC 110 may communicate with one or more visibility tool(s) 118 located in or separate from TBE(s) 108 to obtain feedback information or other data.

In some embodiments, TEC 110 or another entity may utilize test results 116 (e.g., recent or prior test results) to improve or adjust EFC selection logic or other analyze various aspects of testing and NTS 102. For example, after running one or more test sessions involving a test environment, TEC 110 or another entity may analyze test results to determine whether the test sessions generated detailed enough metrics. In this example, if the metrics are not enough to achieve a user declared test objective, EFC selection logic may be modified to select higher fidelity TBEs 108 for future similar situations.

SUT 118 may be any suitable entity or entities (e.g., devices, systems, or platforms) for receiving, processing, forwarding, and/or sending one or more messages (e.g., packets). For example, SUT 118 may include a network node, a network switch, a network router, a network interface card, a packet forwarding device, or one or more virtual network functions (VNF). In some embodiments, SUT 118 may be part of the same network, the same data center, or a same switching fabric as NTS 102 or related entities, e.g., TBE(s) 108 or traffic generators.

In some embodiments, NTS 102 may dynamically configure a test environment (e.g., a test bed) with emulated and/or non-emulated TBEs 108, where the fidelity level of TBEs 108 in the test environment can be manipulated and controlled prior to and during the execution of a test involving SUT 118. For example, NTS 102 may provide a GUI or other UI to allow user 101 to define an abstract or high-level test environment, which includes various TBEs 108. In this example, user 101 may provide or indicate emulation fidelity attributes associated with each abstracted TBE 108, group of TBEs 108, and/or the test environment. Continuing with this example, NTS 102 may use these attributes and related mappings 114 to intelligently select and configure appropriate TBEs 108 providing varying degrees of emulation fidelity for a network test while achieving test objectives or requirements.

It will be appreciated that FIG. 1 is for illustrative purposes and that various depicted entities, their locations, and/or their functions described above in relation to FIG. 1 may be changed, altered, added, or removed.

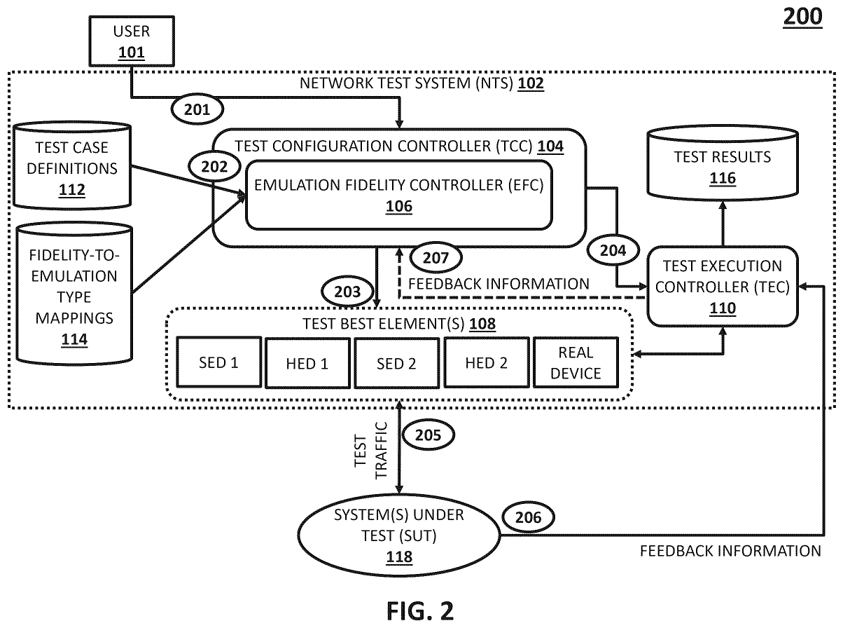

FIG. 2 is a diagram illustrating an example process 200 for setting up a test bed environment comprising appropriate TBEs 108, e.g., real or emulated DUT devices, as well as other real or emulated network elements including components of data center switching fabrics, servers, gateways, load balancers, mobile core network elements, O-RAN elements, etc.

In some embodiments, unless otherwise described, elements depicted in FIG. 2 may include similar or same functionality as those same-numbered elements depicted in FIG. 1.

Referring to process 200, in step 201, user 101 may interact with and provide test configuration information or other data to TCC 104. In some embodiments, user 101 may select or modify a test case (e.g., via a GUI or another interface) from a group of stored test case definitions 112 (e.g., previously saved test case definition files).

In step 202, TCC 104 may utilize EFC 106 or related functionality for configuring and deploying test system resources (e.g., TBEs 108) in a test environment (e.g., a test bed). In such embodiments, TCC 104 and/or EFC 106 may access user input, related test case definition information, and/or relevant mappings 114 and may use this information in determining what type(s) of emulation are needed or appropriate for TBE(s) 108 or a group of TBEs 108 for a given test session.

In some embodiments, TCC 104 and/or EFC 106 may compute (e.g., dynamically or on-the-fly) emulation type determinations based on user input or information contained in a test case definition. In some embodiments, TCC 104 and/or EFC 106 may utilize mappings 114 (e.g., emulation type determination or selection rules or logic) when performing emulation type determination or selections for TBE(s) 108 or a group of TBEs 108.

In some embodiments, TCC 104 and/or EFC 106 may be adapted to analyze a test case definition and/or a user-specified test intent, test objective, or goal, and to intelligently optimize selection and deployment of test system resources (e.g., TBEs 108) based on specific emulation fidelity needs of key/critical areas of the test environment. For example, user 101 may provide test bed topology information for a data center use case and then, e.g., via a test system UI, user 101 may indicate or declare that observation of congestion performance of one specific area (e.g., a set of ports) of the data center's switching fabric is a test objective or important to user 101. In this example, NTS 102 or another entity (e.g., EFC 106) may determine that a software emulation of the switching fabric of interest (e.g., a SED) would not provide the needed fidelity to provide the user with the desired congestion performance information. As such, in this example, NTS 102 or another entity may configure that portion of the switching fabric to be emulated using a hardware emulation (e.g., a HED) that can provide the desired congestion performance information, e.g., high fidelity congestion performance metrics during execution of the test.

In some embodiments, TCC 104 and/or EFC 106 may be adapted to intelligently optimize selection and deployment of test system resources (e.g., TBEs 108) for a test environment using various test environment characteristics or test case data, e.g., a network type, traffic types, or related data. For example, user 101 may provide test bed topology information associated with a mobile core network and user 101 may indicate or declare that testing this topology should include both control plane and user plane test traffic and that obtaining detailed performance metrics associated with handling control plane traffic is a test objective or important to user 101. In this example, NTS 102 or another entity (e.g., EFC 106) may determine which paths through the test environment the control plane traffic will traverse and may provisioned these paths with high fidelity hardware emulations of TBEs 108 (e.g., HEDs acting as routers, core nodes, etc.). Continuing with this example, other portions of the test environment (e.g., nodes that carry only user plane traffic) may be provisioned with low (er) fidelity software emulations of TBEs 108.

In step 203, after emulation type determinations, TCC 104 may generate test system resource configuration instructions for configuring TBEs and related test environment and may use these instructions when configuring and/or deploying TBEs 108 in the test environment (e.g., a test bed).

In step 204, after test environment configuration, TEC 110 may initiate a test session and related test feedback collection (e.g., by triggering traffic generators, test agents, and/or monitoring agents).

In step 205, testing may occur including sending and receiving test traffic via TBEs 108 and/or SUT 118.

In step 206, after or during testing, test feedback information may be collected and/or provided to TEC 110 or another entity for analysis or reporting. For example, a monitoring agent in SUT 118 may utilize a management network or other method for providing SUT performance metrics, network metrics, and/or copies of test traffic or responses thereto.

In step 207, TEC 110 and/or another entity may send feedback information or related data (e.g., emulation fidelity performance data) to one or more entities, such as a data store like test results 116, TCC 104 and/or EFC 106. In some embodiments, NTS 102 or another entity (e.g., EFC 106) may use feedback information or related data from testing to change or adjust emulation type determinations or related logic.

It will be appreciated that process 200 is for illustrative purposes and that different and/or additional actions may be used. It will also be appreciated that various actions described herein may occur in a different order or sequence.

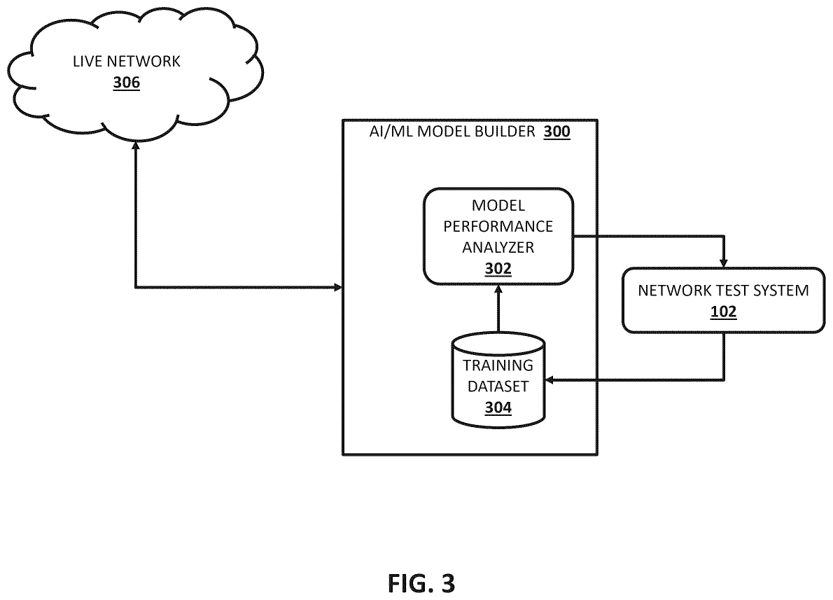

FIG. 3 is a diagram illustrating an example artificial intelligence or machine learning (AI/ML) model builder 300 utilizing training data derived from testing. AI/ML model builder 300 may be any suitable entity or entities (e.g., (e.g., software executing on a processor, a field-programmable gateway array (FPGA), an application-specific integrated circuits (ASIC), or a combination of software, an ASIC, or an FPGA) for generating and training an AI/ML model, e.g., usable for emulating a network node, predicting or analyzing network behavior, or some other test related purpose. For example, NTS 102 may generate or supplement training data set content usable for designing and/or training an AI/ML model for predicting or analyzing network behavior(s). Example AI/ML models may include artificial neural network (ANN) models, genetic algorithm models, etc.

In some embodiments, AI/ML model builder 300 may be implemented in or using NTS 102 or related resources. For example, NTS 102 may be a dynamic training data generation sub-system or component of AI/ML model builder 300. In another example, AI/ML model builder 300 may be a AI sub-system or component of NTS 102.

Referring to FIG. 3, AI/ML model builder 300 may include a model performance analyzer 302 and a training dataset 304. Model performance analyzer 302 may be any suitable entity or entities (e.g., (e.g., software executing on a processor, a field-programmable gateway array (FPGA), an application-specific integrated circuits (ASIC), or a combination of software, an ASIC, or an FPGA) for analyzing an AI/ML model's performance and/or determining whether additional training or changes are needed for the AI/ML model. For example, model performance analyzer 302 may be configured for receiving captured traffic data, metadata, or other information from live network 106 (e.g., a non-emulated network controlled by a test operator with user traffic) and may use this information to test or analyze whether a particular AI/ML model accurately predicted the behavior of live network 106.

Training dataset 304 may represent data collected from live network 106 or other sources and may be used in generating and/or training an AI/ML model. In some embodiments, training dataset 304 may include multiple datasets or portions (e.g., an initial training set, a second training set, a refinement set, a final training set, etc.) and each portion may be used in different phases of training. In some embodiments, data in training dataset 304 may be collected over time or from one or more networks or network configurations and may include network data and metadata, e.g., captured traffic from a live network monitoring system located or from live network 306, generated by a simulation, etc.

In some embodiments, AI/ML model builder 300 may generate and train a network performance predictor AI/ML model using training dataset 304 or a portion thereof including operational and performance data collected from live network 106 or another source, e.g., a test network. In such embodiments, the network performance predictor AI/ML model may be tested (e.g., once or multiple times by model performance analyzer 302) against the actual performance of live network 306. If the AI/ML model performs poorly, it may be determined (e.g., by model performance analyzer 302) that data in training dataset 304 is insufficient to adequately model or predict the network behavior of interest, and that a “higher dimensional” or “higher fidelity” (e.g., more precise and/or more realistic data) is needed. For example, model performance analyzer 302 may determine that in order to adequately model the network behavior of interest, data center switching fabric queue depth data needs to be collected and added to training dataset 304. In this example, NTS 102 can be configured to execute a test session that involves deploying high fidelity TBEs 108 (e.g., high fidelity hardware emulations for associated switching fabric elements) in the test environment. Continuing with this example, switch queue depth data generated during this test session may be captured (and optionally formatted) and then provided to AI/ML model builder 300 and/or training dataset 304. After obtaining the switch queue depth data, AI/ML model builder 300 may use the updated training dataset 304 to re-train a new AI/ML model or augment the existing model, e.g., via a federated learning-like process, etc.

In some embodiments, AI/ML model builder 300 may execute a training dataset adjustment process for triggering and/or causing NTS 102 to execute one or more test sessions for obtaining new or additional data for training dataset 304. For example, AI/ML model builder 300 may execute a training dataset adjustment process multiple times (e.g., for as many iterations as are necessary) to produce an AI/ML model with satisfactory performance.

It will be appreciated that FIG. 3 is for illustrative purposes and that various depicted entities, their locations, and/or their functions described above in relation to FIG. 3 may be changed, altered, added, or removed.

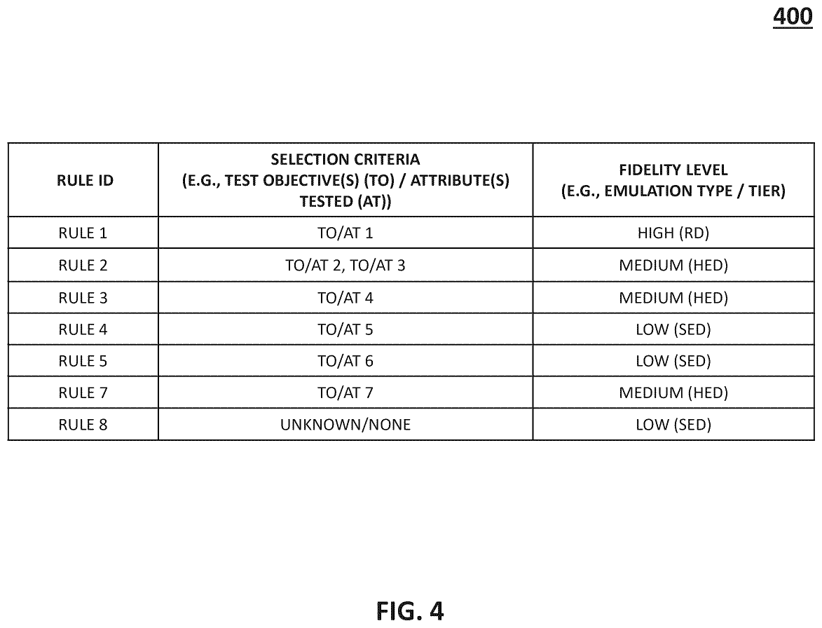

FIG. 4 is a diagram illustrating example emulation fidelity selection information 400 for selecting and/or configuring appropriate TBE(s) 108 or a class, group, or tier thereof. In some embodiments, information 400 may include any suitable information for determining an appropriate TBE to use in a network test environment based on user input or other information, e.g., a test objective, a test requirement, metrics needed or used in measuring SUT performance, etc. For example, information 400 may include a selection rule identifier (ID), one or more selection criteria (e.g., a test objective or metrics tested), and a corresponding fidelity level (e.g., a tier or other indicator for selecting appropriate TBE(s) 108.

In some embodiments, information 400 or other data may be accessed and/or stored by NTS 102 and/or other entities (e.g., TCC 104, EFC 106, etc.) using one or more data structures or storage devices. For example, an accessible data store, such as mappings 114, comprising information 400 or a portion thereof.

Referring to FIG. 4, information 400 may be depicted using a table representing various types of data associated with selecting and/or configuring appropriate TBE(s) 108 or a class, group, or tier thereof. For example, each table row depicted in FIG. 4 may represent a particular set of selection criteria and a corresponding fidelity level or TBE related information.

A selection rule ID may include any suitable information for selecting and/or configuring appropriate TBE(s) 108 or a class, group, or tier thereof. For example, a selection rule ID may be a value (e.g., an alphanumeric value, an integer, or a letter) that uniquely identifies a set of selection criteria and a corresponding priority level. In this example, the selection rule ID may act as a lookup value or as part of a lookup value (e.g., along with a test session identifier and/or a test operator identifier) for determining associated selection criteria and a fidelity level or TBE related information.

Selection criteria may include any suitable information for determining a particular TBE or a group, tier, or class of TBE. For example, selection criteria may include logic or data that filters or selects appropriate TBE(s) 108 using user input or other data, e.g., a test objective, a test requirement, metrics tested or used in testing. In this example, NTS 102 and/or another entity (e.g., TCC 104, EFC 106, etc.) may use the selection criteria to determine an appropriate fidelity level or related TBE(s) 108.

A fidelity level may include any suitable information for indicating appropriate TBE(s) 108 or a class, group, or tier thereof. For example, a fidelity level may include data (e.g., actual resource IDs, TBE image identifiers, tier labels, etc.) or logic for indicating appropriate TBE(s) 108 or a class, group, or tier thereof. In some embodiments, a fidelity level may include a value based on a classification or ranking system. For example, a fidelity level may be one of three different values, “high”, “medium”, or “low”. In another example, a fidelity level may be a value between 1-10, where 1 represents the lowest fidelity tier and 10 represents the highest fidelity tier. In some embodiments, a fidelity level may also include information indicating particular TBE(s) 108 that meet the criteria, e.g., a list or set of TBE identifiers.

It will be appreciated that information 400 in FIG. 4 is for illustrative purposes and that different and/or additional information may also be stored or maintained. Further, it will be appreciated that information 400 or related data may be stored in various data structures, memories, or computer readable media and that information 400 or related data may be stored in one or more locations.

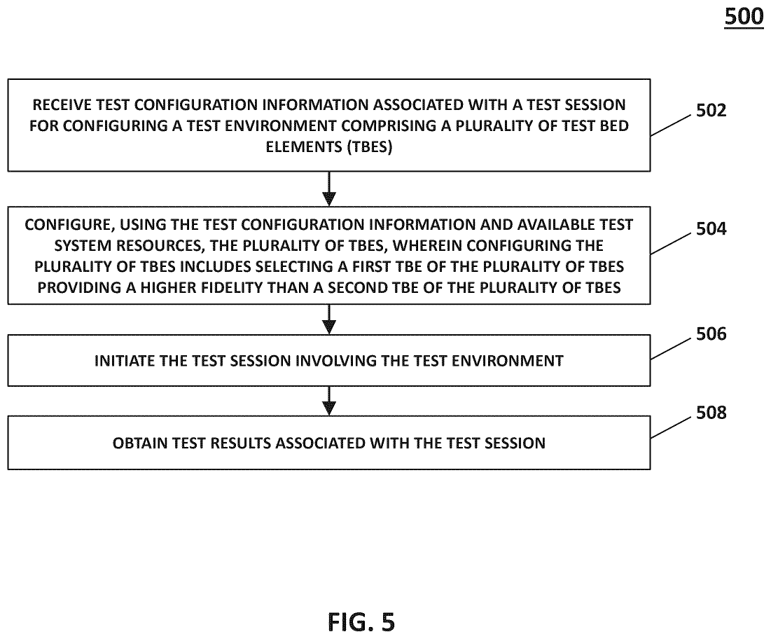

FIG. 5 is a diagram illustrating an example process 500 for providing a network test environment with variable emulation fidelity. In some embodiments, process 500, or portions thereof, may be performed by or at NTS 102 (e.g., a test system), TCC 104, EFC 106, TEC 110, and/or another node or module. In some embodiments, process 500 may include steps 502, 504, 506, and/or 508.

Referring to process 500, in step 502, test configuration information associated with a test session for configuring a test environment comprising a plurality of TBEs (e.g., TBEs 108 such as HEDs, SED, and/or real devices) may be received.

In some embodiments, test configuration information may include declarative or intent-based user input indicating a test objective. For example, a test objective may be related to measuring or monitoring a metric or characteristic of SUT 118 and/or a metric or characteristic of TBE(s) 108 involved in testing SUT 118.

In step 504, the plurality of TBEs may be configured using the test configuration information and available test system resources. In some embodiments, configuring the plurality of TBEs may include selecting a first TBE (e.g., a real or non-emulated network switch) of the plurality of TBEs providing a higher fidelity than a second TBE (e.g., a software-based emulated network switch) of the plurality of TBEs.

In some embodiments, selecting a first TBE of a plurality of TBEs providing a higher fidelity than a second TBE of the plurality of TBEs may include determining, using a test objective, that achieving the test objective involves the first TBE providing a higher fidelity than the second TBE.

In some embodiments, determining that achieving a test objective involves a first TBE providing a higher fidelity than a second TBE may include determining that a first test bed portion or area has a substantially impact on achieving the test objective and determining that a second test bed portion or area lacks a substantially impact on achieving the test objective. In such embodiments, the first TBE may be of the first test bed portion or area and the second TBE may be of the second test bed portion or area.

In some embodiments, determining that achieving a test objective involves a first TBE providing a higher fidelity than a second TBE may include determining that a second TBE does not provide precise information or provide access to useful information for achieving or testing the test objective but determining that a first TBE does provide precise information or access to useful information for achieving or testing the test objective.

In step 506, the test session involving the test environment may be initiated. For example, TEC 110 may start a TG to send test traffic to SUT 118 via one or more TBEs 108, e.g., software-based emulated network switches.

In step 508, test results associated with the test session may be obtained. For example, SUT 118 or a monitoring agent may provide feedback information to NTS 102 or a related test analyzer indicating whether SUT performance was expected or appropriate based on the test scenario and capabilities of SUT 118. In this example, the test results may include traffic metrics, performance metrics, timestamped traffic, or other information usable for analysis or diagnostics of SUT 118.

In some embodiments, NTS 102 or another entity may analyze test results or related data (e.g., from SUT 118, monitoring agents, or other test system related entities), generate feedback information for adjusting the fidelity of the test environment (e.g., feedback information may indicate that captured test metrics are imprecise or not precise enough to achieve a test objective or may indicate that the currently utilized TBE can be downgraded and still achieve the test objective); adjust the fidelity of the test environment, wherein adjusting the fidelity of the test environment may include adjusting a fidelity level of the first TBE, replacing the first TBE with the second TBE or a third TBE, or adjusting a fidelity level of the second TBE; initiating a second test session involving the test environment; and obtaining and reporting test results associated with the second test session.

In some embodiments, NTS 102 or another entity (e.g., AI/ML model builder 302) may use test results (e.g., from one or more test session involving one or more test environments) to train an AI/ML model for predicting network performance or SUT performance; initiate a second test session for testing the AI/ML model; and obtain test results associated with the second test session.

In some embodiments, after obtaining test results associated with a second test session, NTS 102 or another entity (e.g., AI/ML model builder 302) may analyze analyzing the test results associated with the second test session; determine, using analysis information obtaining by analyzing the test results associated with the second test session, that the AI/ML model performed poorly; generate feedback information for adjusting the fidelity of the test environment (e.g., feedback information may indicate that the currently utilized TBE can be downgraded and still achieve the test objective or may indicate that the currently utilized TBE needs to be upgrade (e.g., replaced by a higher fidelity TBE) to achieve the test objective); adjust the fidelity of the test environment, wherein adjusting the fidelity of the test environment may include adjusting a fidelity level of the first TBE, replacing the first TBE with the second TBE or a third TBE, or adjusting a fidelity level of the second TBE; initiate a third test session involving the test environment; and obtaining test results associated with the third test session for use in further training of the AI/ML model.

In some embodiments, a first TBE (e.g., selected, configured, and used in a test environment by NTS 102) may be a non-emulated TBE (e.g., a real device) and a second TBE (e.g., available for use by NTS 102 but not currently used in a test environment) may be a hardware-based emulated TBE (e.g., a HED).

In some embodiments, a first TBE (e.g., selected, configured, and used in a test environment by NTS 102) may be a non-emulated TBE (e.g., a real device) and a second TBE (e.g., available for use by NTS 102 but not currently used in a test environment) may be a software-based emulated TBE (e.g., a SED).

In some embodiments, a first TBE (e.g., selected, configured, and used in a test environment) may be a hardware-based emulated TBE (e.g., a HED) and a second TBE (e.g., available for use by NTS 102 but not currently used in a test environment) may be a software-based emulated TBE (e.g., a SED).

In some embodiments, a first TBE (e.g., selected, configured, and used in a test environment by NTS 102) may include an emulated or non-emulated version of a network switch, a router, a smartswitch, a network element, a server, an application server, a processing offload or accelerator device, a machine learning processor, a data center element, an open radio access network (O-RAN) element, a core network element, a fifth generation (5G) core network element, or a sixth generation (6G) core network element.

It will be appreciated that process 500 is for illustrative purposes and that different and/or additional actions may be used. It will also be appreciated that various actions described herein may occur in a different order or sequence.

It should be noted that NTS 102 and/or functionality described herein may constitute a special purpose computing device. Further, NTS 102 and/or functionality described herein can improve the technological field of testing networks or other equipment. For example, by using TBE(s) 108 having variable fidelity, an example network test system can perform network testing that may not have been possible using previous test systems or that may have been very time consuming, expensive, and potentially prone to human-error (e.g., because of manual (re-)cabling or required for different test sessions).

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing a network test environment with variable emulation fidelity, the method comprising:
at a test system implemented using at least one processor:
receiving a test case definition that includes one or more emulation fidelity attributes;
configuring, based on the test case definition and available test system resources, a plurality of test bed elements (TBEs), wherein configuring the plurality of TBEs includes automatically selecting, based at least in part on the one or more emulation fidelity attributes, a first TBE of the plurality of TBEs providing a higher emulation fidelity than a second TBE of the plurality of TBEs;
initiating a test session involving a test environment including the first TBE; and
logging test results associated with the test session.

2. The method of claim 1 comprising analyzing the test results, automatically adjusting the fidelity level of at least one of the TBEs in the test environment and re-executing the test session.

3. The method of claim 1 comprising:
at the test system:
using the test results to train an artificial intelligence or machine learning (AI/ML) model for predicting network performance or SUT performance;
initiating a second test session for testing the AI/ML model; and
obtaining test results associated with the second test session.

4. The method of claim 3 comprising:
at the test system:
analyzing the test results associated with the second test session;
determining, using analysis information obtaining by analyzing the test results associated with the second test session, that the AI/ML model performed poorly;
generating feedback information for adjusting the fidelity of the test environment;
adjusting the fidelity of the test environment, wherein adjusting the fidelity of the test environment includes adjusting a fidelity level of the first TBE, replacing the first TBE with the second TBE or a third TBE, or adjusting a fidelity level of the second TBE;
initiating a third test session involving the test environment; and
obtaining test results associated with the third test session for use in further training of the AI/ML model.

5. The method of claim 1 wherein the test configuration information includes declarative or intent-based user input indicating a test objective.

6. The method of claim 5 wherein selecting the first TBE of the plurality of TBEs providing a higher emulation fidelity than the second TBE of the plurality of TBEs includes determining, using the test objective, that achieving the test objective involves the first TBE providing a higher emulation fidelity than the second TBE.

7. The method of claim 6 wherein determining that achieving the test objective involves the first TBE providing a higher emulation fidelity than the second TBE includes determining that a first test bed portion or area has a substantially impact on achieving the test objective and determining that a second test bed portion or area lacks a substantially impact on achieving the test objective, wherein the first TBE is of the first test bed portion or area and the second TBE is of the second test bed portion or area.

8. A system for providing a network test environment with variable emulation fidelity, the system comprising:
at least one processor;
a test system implemented using the at least one processor, wherein the test system is configured for:
receiving a test case definition that includes one or more emulation fidelity attributes;
configuring, based on the test case definition and available test system resources, a plurality of test bed elements (TBEs), wherein configuring the plurality of TBEs includes automatically selecting, based at least in part on the one or more emulation fidelity attributes, a first TBE of the plurality of TBEs providing a higher emulation fidelity than a second TBE of the plurality of TBEs;
initiating a test session involving a test environment including the first TBE; and
logging test results associated with the test session.

9. The system of claim 8 comprising analyzing the test results, automatically adjusting the fidelity level of at least one of the TBEs in the test environment and re-executing the test session.

10. The system of claim 9 comprising analyzing the test results, automatically adjusting the emulation fidelity level of at least one of the TBEs in the test environment and re-executing the test session.

11. The system of claim 8 wherein the test system is further configured for:
analyzing the test results;
generating feedback information for adjusting the fidelity of the test environment;
adjusting the emulation fidelity of the test environment, wherein adjusting the fidelity of the test environment includes adjusting a fidelity level of the first TBE, replacing the first TBE with the second TBE or a third TBE, or adjusting a fidelity level of the second TBE;
initiating a second test session involving the test environment; and
obtaining and reporting test results associated with the second test session.

12. The system of claim 8 wherein the test system is further configured for:
using the test results to train an artificial intelligence or machine learning (AI/ML) model for predicting network performance or SUT performance;
initiating a second test session for testing the AI/ML model; and
obtaining test results associated with the second test session.

13. The system of claim 12 wherein the test system is further configured for:
analyzing the test results associated with the second test session;
determining, using analysis information obtaining by analyzing the test results associated with the second test session, that the AI/ML model performed poorly;
generating feedback information for adjusting the fidelity of the test environment;
adjusting the fidelity of the test environment, wherein adjusting the fidelity of the test environment includes adjusting a fidelity level of the first TBE, replacing the first TBE with the second TBE or a third TBE, or adjusting a fidelity level of the second TBE;
initiating a third test session involving the test environment; and
obtaining test results associated with the third test session for use in further training of the AI/ML model.

14. The system of claim 8 wherein the test system is further configured for:
in an iterative manner until a stop condition is met:
adjusting, using recent test results or derived information therefrom, the fidelity of the test environment, wherein adjusting the fidelity of the test environment includes adjusting a fidelity level of the first TBE, replacing the first TBE with the second TBE or a third TBE, or adjusting a fidelity level of the second TBE;
initiating a new test session involving the test environment; and
obtaining and analyzing test results associated with the new test session.

15. The system of claim 8 wherein the test configuration information includes declarative or intent-based user input indicating a test objective.

16. The system of claim 15 wherein the test system is further configured for determining, using the test objective, that achieving the test objective involves the first TBE providing a higher fidelity than the second TBE.

17. The system of claim 16 wherein the test system is further configured for determining that a first test bed portion or area has a substantially impact on achieving the test objective and determining that a second test bed portion or area lacks a substantially impact on achieving the test objective, wherein the first TBE is of the first test bed portion or area and the second TBE is of the second test bed portion or area.

18. The system of claim 8 wherein the first TBE includes an emulated or non-emulated version of a network switch, a router, a smartswitch, a network element, a server, an application server, a processing offload or accelerator device, a machine learning processor, a data center element, an open radio access network (O-RAN) element, a core network element, a fifth generation (5G) core network element, or a sixth generation (6G) core network element.

19. A non-transitory computer readable medium having stored thereon executable instructions embodied in the non-transitory computer readable medium that when executed by at least one processor of a test system cause the test system to perform steps comprising:
receiving a test case definition that includes one or more emulation fidelity attributes;
configuring, based on the test case definition and available test system resources, a plurality of test bed elements (TBEs), wherein configuring the plurality of TBEs includes automatically selecting, based at least in part on the one or more emulation fidelity attributes, a first TBE of the plurality of TBEs providing a higher emulation fidelity than a second TBE of the plurality of TBEs;
initiating a test session involving a test environment including the first TBE; and
logging test results associated with the test session.

20. The non-transitory computer readable medium of claim 19 comprising analyzing the test results, automatically adjusting the fidelity level of at least one of the TBEs in the test environment and re-executing the test session.
